(19) United States
(12) Patent Application Publication
(10) Pub. No.: US 2005/0009539 A1
(43) Pub. Date: Jan. 13, 2005

(54) Method and apparatus to broadcast content to handheld wireless devices via digital set-top-box receivers

(76) Inventor: Fathy Yassa, Soquel, CA (US)

Correspondence Address: Fathy Yassa, 4439 Esta Lane, Soquel, CA, 95073, US

(21) Appl. No.: 10/839,783

(22) Filed: Apr. 27, 2004

Related U.S. Application Data
(60) Provisional application No. 60/465,986, filed on Apr. 28, 2003.

(51) Int. Cl. H04Q 7/20

(52) U.S. Cl. 455/456.6

(57) ABSTRACT

An exemplary method and apparatus to deliver rich media to wireless hand held devices.

### CLAIM OF PRIORITY

The present invention claims priority from provisional application 60/465,986 filed on Apr. 28, 2003 and incorporates said application by reference as if fully set forth herein.

### FIELD OF THE INVENTION

The invention herein discloses an exemplary method and apparatus to transmit content to a viewer's wireless device as an alternative or complement to TV viewing, using a digital satellite, cable or terrestrial set-top-box, an internet enabled set-top box, or an analog broadcast with digital extraction and a wireless reception device.

### BACKGROUND

Referring to FIG. 1, currently the vast majority of digital television program providers, whether cable, satellite, or terrestrial transmissions, transmit digital content from transmitting station 110 to satellite 125 via channel 120. Satellite 125 retransmits the digital content digital to one or more satellite dishes 130. Satellite dish 130 may be a large satellite dish owned and operated by a local cable company, or it may a personal satellite dish serving one home. The satellite dish then transmits the content, usually via bi-directional coaxial cable 140, to each cable subscriber via set-top-box (STB) 150. STB 150 demodulates, or extracts information from, the digital signal in the form of packets, or fragments, from the carrier, and performs different signal processing techniques, i.e. error correcting, demultiplexing, descrambling and decoding. to decode the digital programs in the form of video, audio or data, and converts such digital data to analog form to playback such decoded signals on a TV set as shown in FIG. 1. Such connection between the playback device (TV) and the STB are done with cables and use the analog signals produced by the STB.

The current system has proven inadequate for most wireless applications, and in particular, to mobile wireless devices. Mobile wireless devices generally fall under the category of hand held devices, and include cell phones, personal digital assistants (pda's), etc. These devices share the common characteristic of being small, easily transported, and useable under most circumstances. Unlike portable computers and other larger mobile devices, hand-held devices do not require a surface to be placed on, nor do they usually have fixed or removable, mass storage devices such as hard drives, magneto-optical drives, or optical drives. The storage is generally limited to on-board memory or small removable memory such as flash media cards.

The difficulty with transmitting content, and in particular, rich media, defined as content exhibiting one or more characteristics of user interaction, advanced animation, and or audio/video is that it requires large bandwidth and bi-directional communication for error correction. Small, wireless devices generally do not have the available bandwidth or sufficient power to reach the content distributor to request that corrupted packets of information be resent.

In the present invention, digital data encoded for handheld devices is transmitted via satellite, cable or terrestrial television digital channels to a STB and wirelessly re-transmitted to a handheld receiver for decoding and playback using modern forms of wireless transmission such as Bluetooth, infrared, fast-infrared (FIR) or 802.11x. Such data can be digitally compressed audio, video, program information, game files, etc.

In the present invention, the set-top box obtains instructions from the wireless device regarding what content to transmit to it. The STB uses the index data supplied by embedded in the data stream to determine what content to transmit.

### BRIEF SUMMARY OF THE INVENTION

The instant invention relates to an exemplary method and apparatus for delivering rich media to wireless hand held devices which do not have sufficient power or bandwidth to obtain the content directly from a content provider. The instant invention solves this problem by sending the rich media to an STB which re-transmits the rich media to the wireless hand held device.

### BRIEF DESCRIPTION OF THE DRAWINGS

FIG. 1 illustrates how the average end-user received rich media.

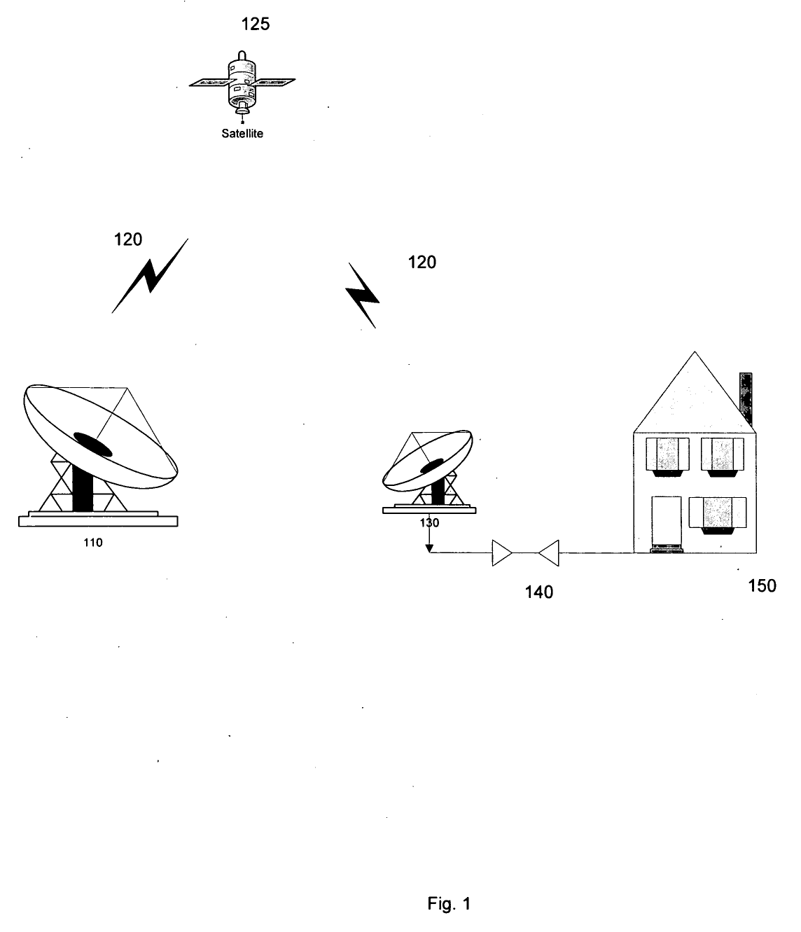

FIG. 2 illustrates a traditional STB and television set-up.

FIG. 3 illustrates one embodiment of the invention

FIG. 4 contrasts two packets of information

FIG. 5 is a flow diagram on one embodiment of the invention

FIG. 6 illustrates the control logic

### DETAILED DESCRIPTION OF THE EMBODIMENTS

The invention herein disclosed provides an exemplary solution to the problem of delivering rich media to wireless devices, and in particular to small hand held devices, by wirelessly enabling STB devices so that they can transmit information to a hand held wireless device. Today, some of the more popular wireless protocols include infra-red, fast infra-red, and 802.11x

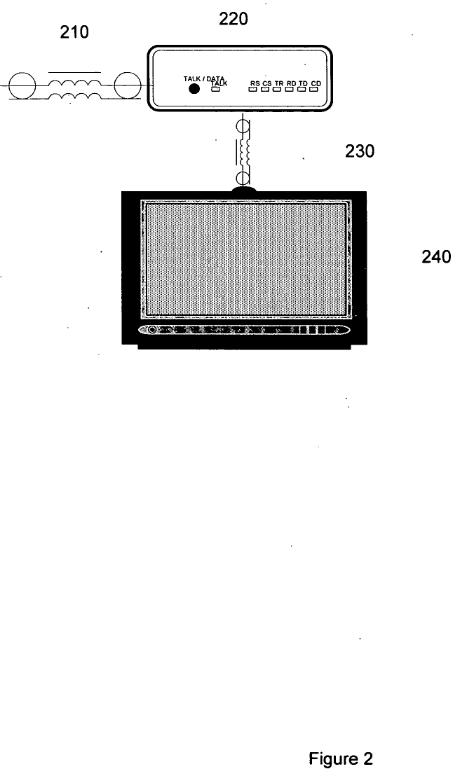

Referring to FIG. 2, FIG. 2 illustrates one traditional embodiment of how most viewers obtain content to their televisions. Rich media arrives at the home via coaxial cable 210. The rich media is divided into packets which include a header, content, and termination information. Said header includes index information including the corresponding channel, time index, name of television show, ratings, etc. The content is received by STB 220. STB 220 reads the index information and transmits only those packets with the channel identifier that the user has requested. Said packets are transmitted via transmission means 230 to television set 240.

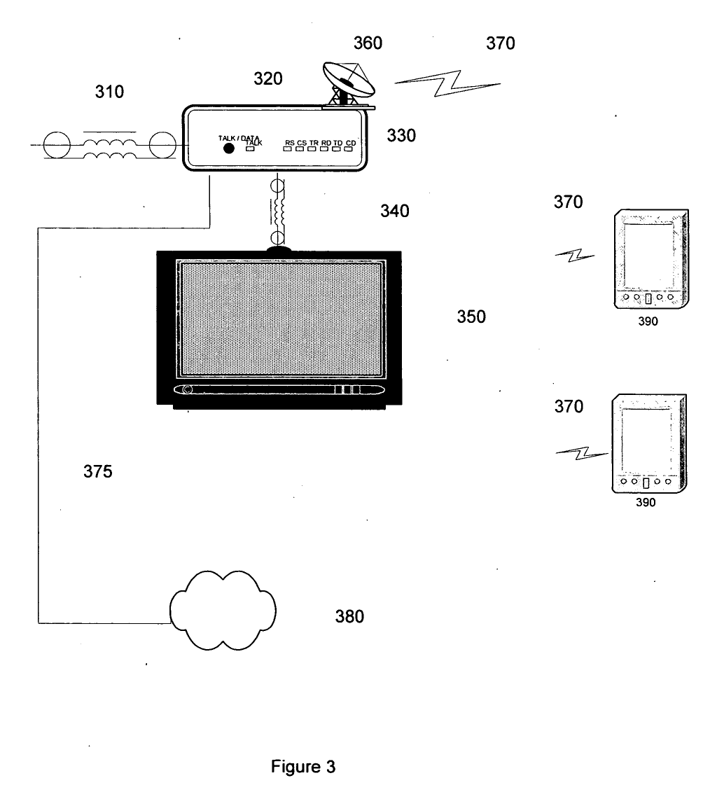

Referring to FIG. 3, FIG. 3 illustrates one embodiment of the invention; STB 320 receives the content via coaxial cable 310. STB 320 is wireless enabled to transmit and received information via wireless communications such as infra-red, FIR, or 802.11x. STB 320 is also configured with two or more tuners 330. Multiple tuners allow different receiving devices to receive different content at the same time. One channel is transmitted via transmission means 340 to television set 350. One or more channels are transmitted wireless via wireless transmitter 360 over one or more bi-directional wireless channels 370, to one or more wireless devices 390. Each wireless device may receive different content up to the number of tuners available (minus the tuner being used by the television set). Such content can be streamed for real time decoding by the handheld device, or downloaded to devices with enough storage capabilities for later decoding or playback. Bi-directional channel 370 allows the hand held devices to re-request corrupted packets from the STB 320, thus allowing rich media to be transmitted. Bi-direction channels 370 may represent diverse technologies, to wit, the STB 320 may transmit using one wireless technology, and receive information such as data or commands via another wireless technology.

In another embodiment of the invention, STB 320 is connected to the public internet 380 via connection means 375. This permits STB 320 to obtain and transmit information from the internet as well.

In another embodiment of the invention, STB 320 receives content from a mass storage device such as a hard drive, an optical drive, or a solid state memory device.

In another embodiment of the invention, the wireless handheld device has an accessory which acts as the STB, but is a dedicated receiver without having any connection to a TV set.

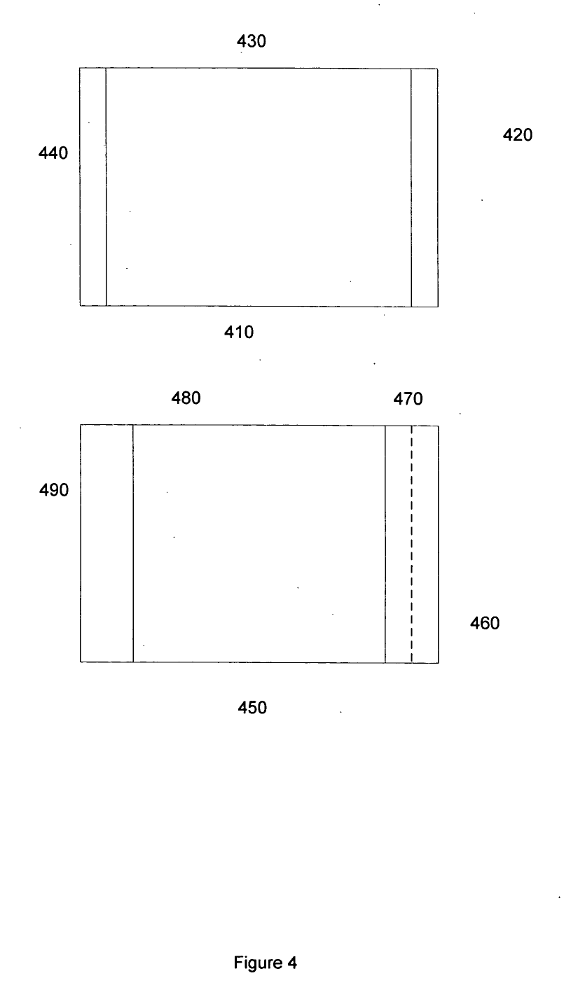

Referring to FIG. 4, FIG. 4 illustrates that the content received by the hand held device may be entire data packets via dedicated channels, or piggy backed onto any unused space in a regular television channel sharing the TV digital data transport and bandwidth. Dedicated channel 410 is composed of header area 420, content area 430, and termination information 440. By contrast, the piggy backed signal, or co-cast, data packet 450, has header area 460, co-cast content area 470, data area 480, and termination area 490.

In one embodiment of the invention, the information received by the STB device is in the native hand held device format. As such the STB device essentially performs a transmission of its contents without further processing.

In another embodiment of the invention, the information received by the STB device is in the native language of the standard TV digital transmission. The STB device would then convert it to the hand held native language before transmitting.

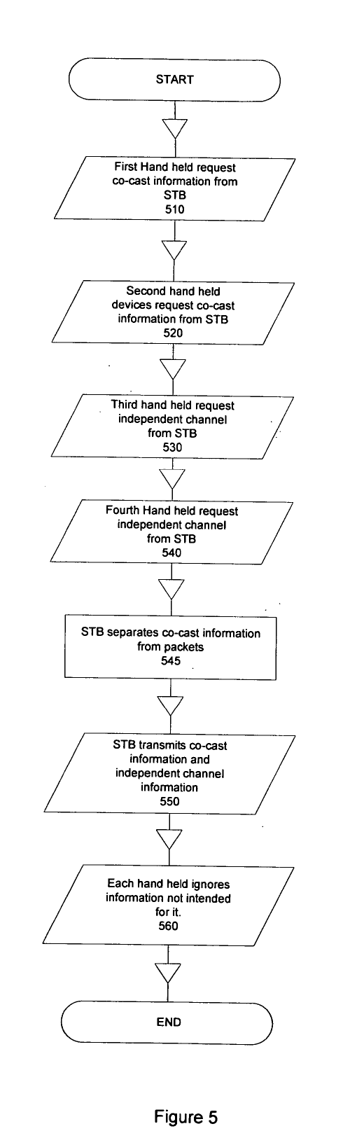

Referring to FIG. 5, FIG. 5 is a flow diagram of one embodiment of the invention. At step 510 a first hand held device requests co-cast information from the STB. At step 20 a second hand held device requests co-cast information from the STB. At step 530 a third hand held device request information from a dedicated channel. At step 540 a fourth handheld device requests information from a dedicated channel. At step 545 multiple tuners separates the co-cast information from the data packets and the independent channel packets. At step 550, the STB transmits the co-cast information and independent channel information to the wireless handheld devices. At step 560 each hand held device receives the transmitted data, ignore the packets not intended for it, and reconstructs the content.

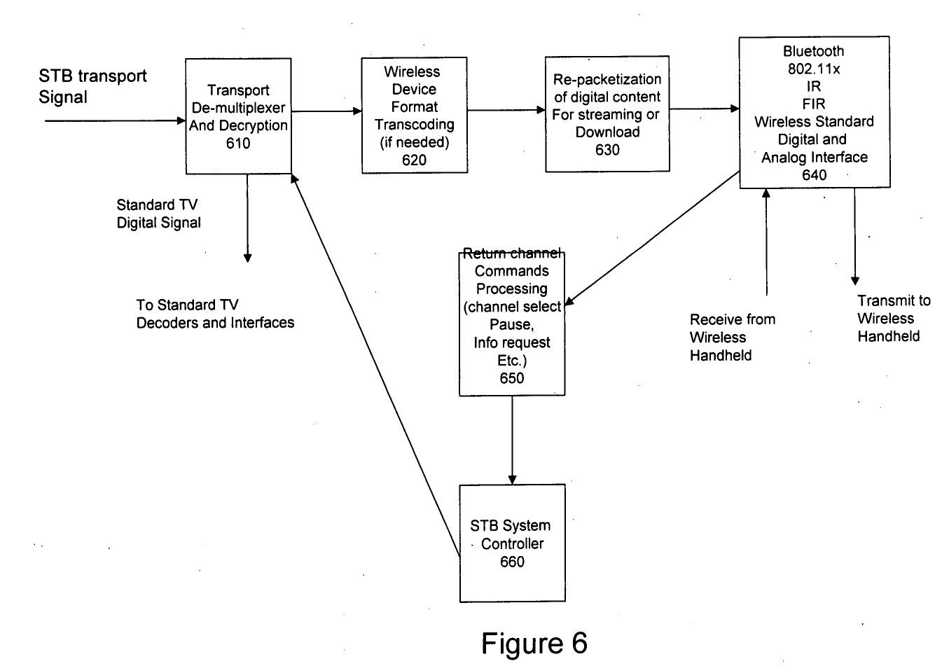

Referring to FIG. 6, FIG. 6 illustrates a block diagram of the control logic of the STB. At step 610, the STB send the input signal through a de-multiplexer and decryption device. At step 620, the STB transcodes the signal into the format for the wireless device. At step 630, the signal is re-packetized for streaming or downloading. At step 640, the signal passes through the wireless interface. At step 650, the STb processes the return channel commands. At step 660 the system controller

1. A method for delivering content to a wireless hand held device comprising the steps of, one or more hand held devices sending a wireless request to a digital set top box for said digital set top box to wirelessly transmit content to said hand held devices; the digital set top box receiving one or more request to wirelessly transmit content to the hand held devices; obtaining content from a content source in the form of digital data packets, reading the index information from each packet, wirelessly transmitting each requested packet to the wireless hand held device.

2. The method of claim 1 where each hand held device requests content from a particular television channel.

3. The method of claim 2 where the television channel is dedicated to content for the hand held device.

4. The method of claim 2, where the television channel is used to co-cast wireless content.

5. The method of claim 1, where the STB obtains the content from a content provider.

6. The method of claim 1, where the STB obtains the content from the internet.

7. The method of claim 1, where the STB obtains the content from a local mass storage device.

8. The method of claim 1, where the STB transmits to the hand held devices using the same wireless means that the hand held devices used to request the content.

9. The method of claim 1, where the STB transmits to the hand held devices using a different wireless means than the hand held devices used to request the content.

10. The method of claim 1, where the STB transmits the content using one wireless transmitter.

11. The method of claim 1, where the STB transmits the content using one transmitter per handheld device.

12. The method of claim 1 further comprising the steps of transporting the signal, de-multiplexing the signal, decrypting the signal, transcoding the signal into a wireless formal, re-packeting the digital content for streaming or downloading, transmitting the signal via one or more wireless protocols, receiving return channel information and System Controller?

13. An exemplary STB configured to wirelessly transmit content to one or more hand held devices comprising a first means for receiving instructions from the hand held devices; a second means for receiving content from a content source; a tuner configured to tune multiple channels; a third means of wirelessly transmitting the content to the hand held devices.

14. The STB of claim 13 where the content source is a content distributor.

15. The STB of claim 13, where the content source is a local mass storage device.

16. The STB of claim 13, where the instruction receiving means, and the transmitting means use the same wireless technology.

17. The STB of claim 13, where the instruction receiving means and the content transmitting means use different wireless technology.

18. The STB of claim 13, where the instruction receiving means and the content transmitting means use the same channel

19. The STB of claim 13, where the instruction receiving means and the content transmitting means use different channels.

20. The tuner of claim 13, where the tuner is multiple tuners.

21. The STB of claim 13, where one wireless means transmits the content to all hand held devices.

22. The STB of claim 13, where multiple wireless means transmits the content to the hand held device.
